(19) United States
(12) Patent Application Publication
(10) Pub. No.: US 2006/0006601 A1
(43) Pub. Date: Jan. 12, 2006

(54) Sealing system with sensor

(76) Inventors: Werner Hufnagel, Grossbettlingen (DE); Eric Kammerer, Langres (FR)

Correspondence Address: HARNESS, DICKEY & PIERCE, P.L.C., P.O. BOX 828, BLOOMFIELD HILLS, MI, 48303, US

(21) Appl. No.: 11/105,325

(22) Filed: Apr. 13, 2005

(30) Foreign Application Priority Data
May 7, 2004 (DE) 102004023315.2

(51) Int. Cl. F16J 15/00

(52) U.S. Cl. 277/317

(57) ABSTRACT

A sealing system comprising a seal with a sealing lip and a sensor device provided with a measuring probe that extends into a space to be sealed off. The measuring probe during the intended use is exposed to the medium to be sealed.

### CROSS-REFERENCE TO RELATED APPLICATIONS

This application claims the benefit of German Patent Application 10 2004 023 315.2, filed May 7, 2004. The disclosure of the above application is incorporated herein by reference.

### FIELD OF THE INVENTION

The present invention relates to a sealing system comprising a seal with a sealing lip and a sensor device.

### BACKGROUND OF THE INVENTION

Sealing systems with a seal and a sensor device are known, for example, from DE 199 51 340. The sensor of the prior-art sealing system is used primarily to determine the rotational speed of a shaft to be sealed off.

Modern motor vehicles often have extended or variable lubricant change intervals. To determine the actual age of the lubricant, a sensor system is needed that will monitor certain parameters and, when a certain limit value is reached, indicate that the lubricant needs to be changed. The sensor system is formed by a measuring probe for determining, for example, the total base number of the lubricant.

### SUMMARY OF THE INVENTION

An object of the invention is to provide a sealing system with a sensor capable of monitoring certain parameters of a lubricant.

To reach the objective, there is provided a sealing system comprising a seal with a sealing lip and a sensor device with a measuring probe extending into a space that is to be sealed off. In this manner, the measuring probe, while being used for the measurement, is exposed to the medium to be sealed off.

During operation the measuring probe extends into the space to be sealed off and is exposed to the lubricant to be monitored. The lubricant parameters to be monitored can thus be determined and evaluated continuously.

In the space to be sealed off, there can be provided a retaining device for the medium to be sealed off and into which the measuring probe extends. At the beginning of its intended use for the measurement, the retaining device fills up with the medium to be sealed off. During operation the measuring probe extends into the retaining device and is constantly wetted by the medium. The volume of the retaining device can be adapted to the requirements of the measuring probe, and of the parameter to be measured. Because during operation the retaining device is constantly wetted by the medium, it is also possible to determine parameters that require a longer measuring period.

In one embodiment, the retaining device is fastened to the seal. The retaining device can thus be molded onto the seal inexpensively and in a simple manner. For example, the retaining device and the seal support element can be fabricated as a single unit.

The retaining device can be provided with a retaining lip that at least partly surrounds a shaft that is to be sealed. A large reservoir is thus formed which, during operation, fills with the medium to be sealed off. This has an advantageous effect on the measuring accuracy of the measuring probe.

The retaining lip can surround the shaft by at least partly touching it. The retaining device thus forms a preceding seal and, during its intended use, is filled with the medium to be sealed off.

In another embodiment, the retaining device is fastened to the sensor device. The sensor device and the retaining device can then be mounted in a seal as a prefabricated unit. The unit can be mounted into commercial seals. The preparation of the seals to enable them to receive the unit is simple and inexpensive.

The retaining device can be provided with a draining hole. During operation, the medium to be sealed off is continuously changed through the draining hole, or the retaining device is freshly filled at the beginning of the operation. This ensures that a different portion of the medium is always being tested. The measuring result can then be applied to the entire medium.

The measuring probe can be designed as a transmitter for measuring the age of the medium to be sealed off. By measuring certain parameters such as the total base number, the measuring probe makes it possible to determine the age of the medium. The determination of the age of the oil permits the use of variable oil change intervals that depend on the actual service life of the oil.

The measuring probe can be made in the form of a transmitter for measuring the temperature and/or pressure and/or filling quantity of the medium to be sealed off. In this manner, data concerning the medium to be sealed off that is important for the operation can be determined. At the same time, a warning signal can be transmitted when temperature, pressure, and filling quantity exceed their limit value.

The seal can be provided with a support element which can have a recess in which the sensor device is disposed. This allows simple and inexpensive fastening of the sensor device.

In the sealing system can be disposed a cleaning arrangement comprising a cleaning line and a cleaning nozzle, with the nozzle directed toward the measuring probe. The cleaning arrangement makes it possible to remove dirt from the measuring probe that could affect the accuracy of the sensor device. The cleaning agent used can consist of compressed air, fresh lubricant, and/or a lubricant-compatible solvent.

It is possible to provide a housing cover with a sealing system, wherein the support element is designed as a sealing flange with a recess accommodating the sensor device.

In one embodiment, a stiffening flange is made of injection-molded plastic material. Stiffening flanges made of injection-molded plastic material are easy and inexpensive to fabricate.

In another embodiment, the stiffening flange is of a metallic material. Stiffening flanges made of metallic material are characterized by high strength.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

In the following, exemplary embodiments of the sealing system according to the invention will be explained in greater detail by reference to the drawings, which, in schematic representation, show the following:

FIG. 1 shows a sealing system with a retaining device fastened to the support element according to a principle of the present invention;

FIG. 2 shows a sealing system according to a principle of the present invention with a retaining device fastened in the opening to be sealed, the seal being disposed on the inner circumference of the adhering part of the retaining device;

FIG. 3 shows a sealing system according to a principle of the present invention with a sealing lip that is arched toward the space to be sealed off;

FIG. 4 shows a housing cover according to a principle of the present invention with a sensor device fastened to the stiffening flange;

FIG. 5 shows a housing cover according to a principle of the present invention with a sensor device fastened to the sealing flange;

FIG. 6 shows a housing cover according to a principle of the present invention with a sensor device fastened to the sealing flange;

FIG. 7 shows a top view of the housing cover according to FIG. 6;

FIG. 8 shows a sealing system according to a principle of the present invention without the retaining device;

FIG. 9 shows a sealing system according to a principle of the present invention with the sensor and a cleaning arrangement; and

FIG. 10 shows a sealing system according to a principle of the present invention with the sensor and with a cleaning arrangement disposed in the seal.

### DETAILED DESCRIPTION OF THE PREFERRED EMBODIMENTS

The following description of the preferred embodiment(s) is merely exemplary in nature and is in no way intended to limit the invention, its application, or uses.

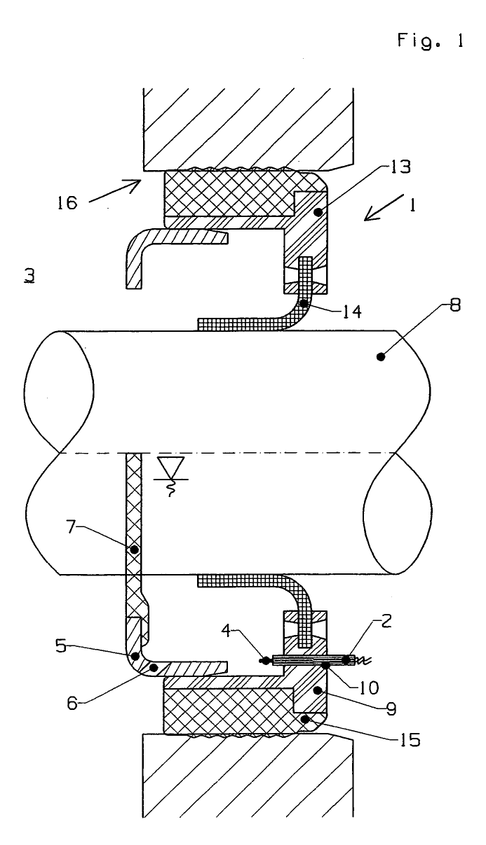

FIG. 1 shows a sealing system 1 according to the present invention. The sealing system 1 includes a seal 13 provided with a sealing lip 14 that is arched toward a space 3 that is to be sealed off. The sealing lip 14 and a static seal 15, which are intended to provide sealing for seal 13 against a housing 16, are fastened to a support element 9. The support element 9 is provided with a recess 10 wherein a sensor device 2 is fastened. A measuring probe 4 extends into the space 3 to be sealed off. The sensor device 2 is designed as a transmitter for determining the age of the medium to be sealed off, and can alternatively also act as transmitter for determining the temperature, pressure, and filling quantity. On support element 9 is fastened a retaining device 5 with a retaining lip 7. The retaining lip 7 surrounds in part, in this embodiment to the extent of one half, a shaft 8 that is to be sealed. The measuring probe 4 extends into the space formed by the retaining lip and during operation is wetted by the medium to be sealed off. At its lowest spot, the retaining device 5 is provided with a draining hole 6 through which the medium to be sealed off drips and, as a result, is constantly renewed during operation. The sensor device 2 is connected with sealing system 1 in a non-destructively detachable manner and can be removed in the direction of the environment. For this purpose, the sensor device 2 can be fastened in the sealing system 1 by means of a bayonet lock or snap-on closure. The sensor device 2 can also be fastened by being pressed in or cemented.

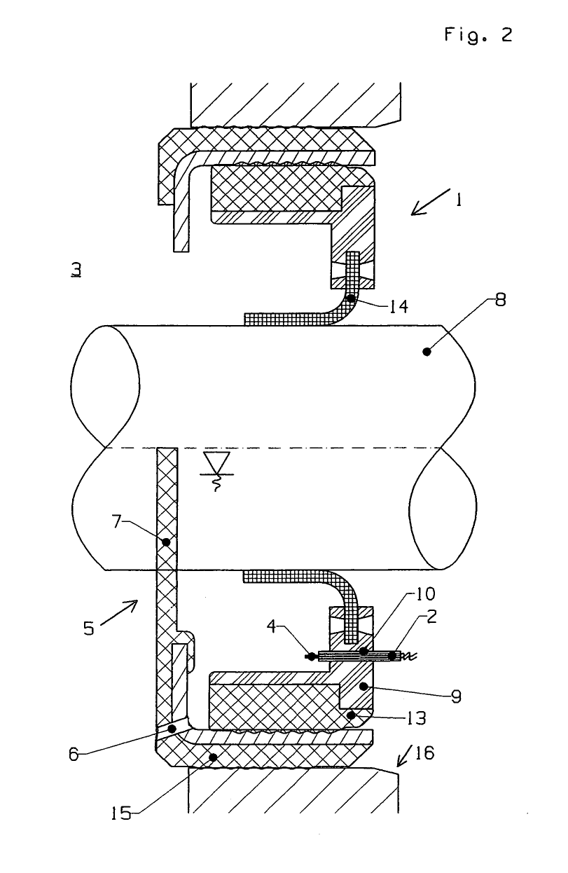

FIG. 2 shows the sealing system of FIG. 1, but with the retaining device 5 in this embodiment being designed as an annular component that surrounds the seal 13 on the side of its outer circumference. The retaining device 5 is provided with a static seal 15 that is intended for sealing against housing 16. A retaining lip 7 of the retaining device 5 surrounds a shaft 8 that is to be sealed off by touching it in part.

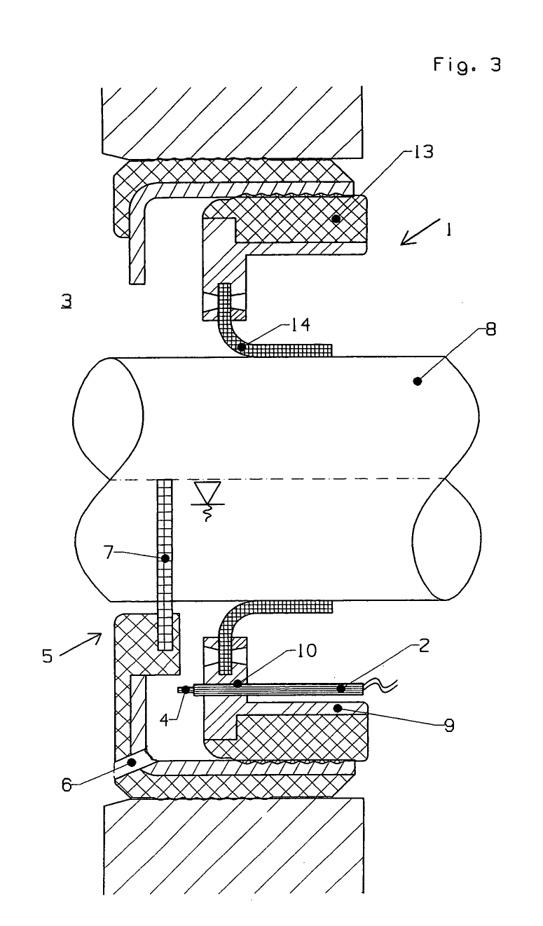

FIG. 3 shows the sealing system 1 of FIG. 2 with the sealing lip 14 of the seal 13 arched away from a space 3 to be sealed off.

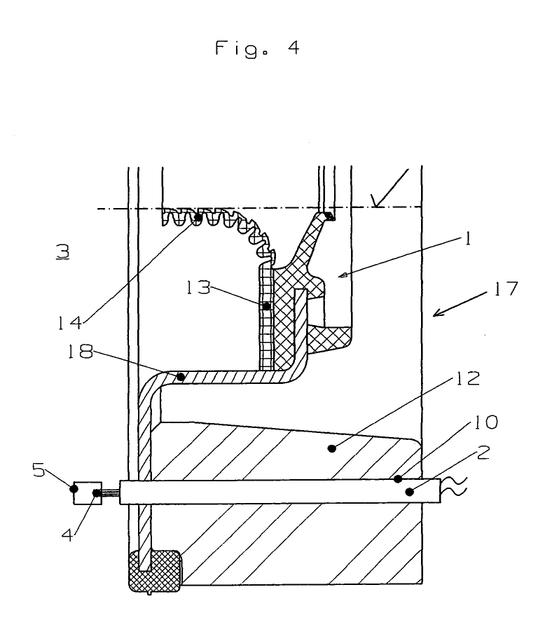

FIG. 4 shows a housing cover 17 with a stiffening flange 12 made of injection-molded light-weight metal, and a sealing flange 18 made of a semi-rigid material. On the sealing flange 18, on the side of the inside circumference, there is provided a seal 13 with a sealing lip 14 arched toward a space 3 that is to be sealed off. The stiffening flange 12 is provided with a recess 10 in which a sensor device 2 is fastened. A measuring probe 4 of the sensor device 2 extends into the space 3 to be sealed off. To sensor device 2 is fastened a retaining device 5 in the form of a tray. During operation, the retaining device 5 keeps the measuring probe 4 continuously wetted with the medium to be sealed off.

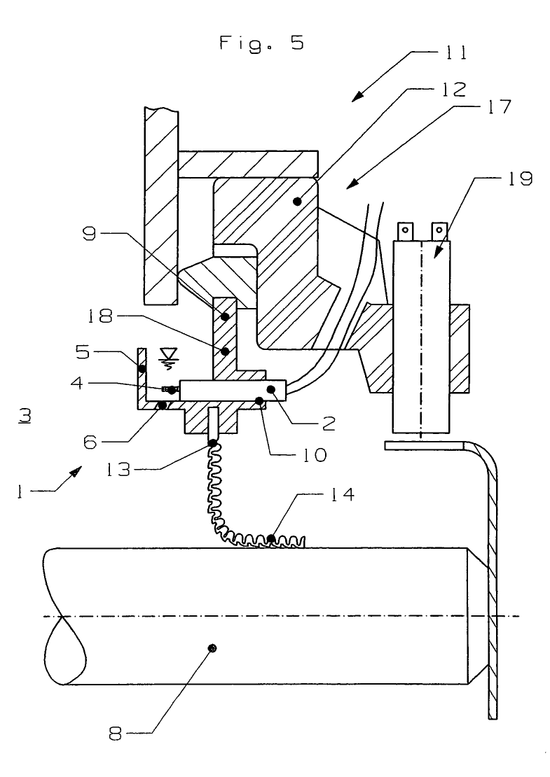

FIG. 5 shows a housing cover 17 with a stiffening flange 12 made of light-weight metal, and a flange 18 made of injection-molded plastic material. On the side of the inside circumference of the sealing flange 18 there is disposed a seal 13 with a sealing lip 14 which is arched away from the space 3 that is to be sealed off. The measuring probe 4 is fastened in a recess 10 of the sealing flange 18. The measuring probe 4 of the sensor device 2 extends into the space 3 that is to be sealed off. To the sealing flange 18 is molded a retaining device 5 that forms a space into which measuring probe 4 extends and in which the medium to be sealed off accumulates to wet the measuring probe 4. At its deepest spot, the retaining device 5 is provided with a draining hole 6 through which the medium to be sealed off drips and during operation is thus continuously renewed. In addition to the sensor device 2, the housing cover 17 holds a device 19 for measuring the speed of rotation.

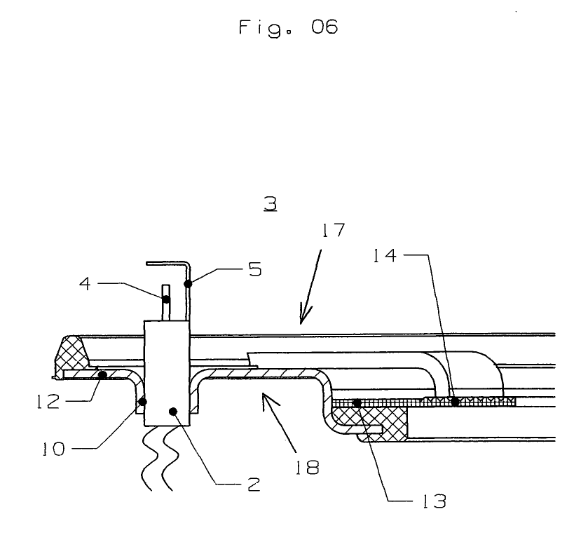

FIG. 6 shows a housing cover 17 with a sealing flange 18 made of drawn sheet metal. On the housing cover 17, on the side of the inside circumference, there is provided a seal 13 with a sealing lip 14. The housing cover 17 is provided with a recess 10 in which the sensor device 2 is fastened. The measuring probe 4 of the sensor device 2 extends into the space 3 that is to be sealed off. To the sensor device 2 is fastened a retaining device 5 in the form of a tray. During operation, the retaining device 5 keeps the measuring probe 4 constantly wetted with the medium to be sealed off.

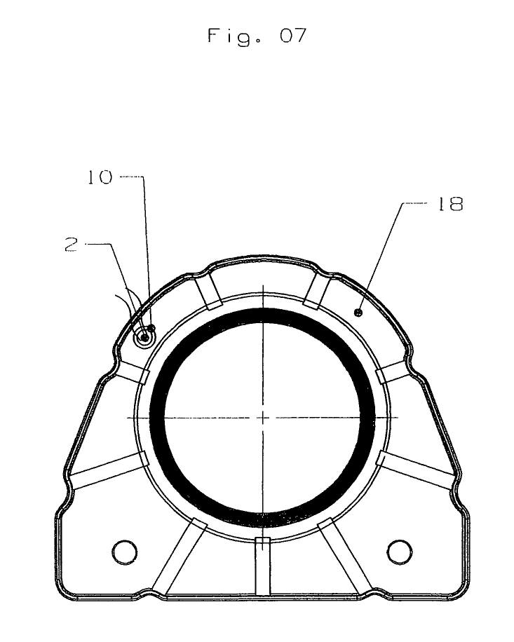

FIG. 7 shows a top view of the housing cover of FIG. 6.

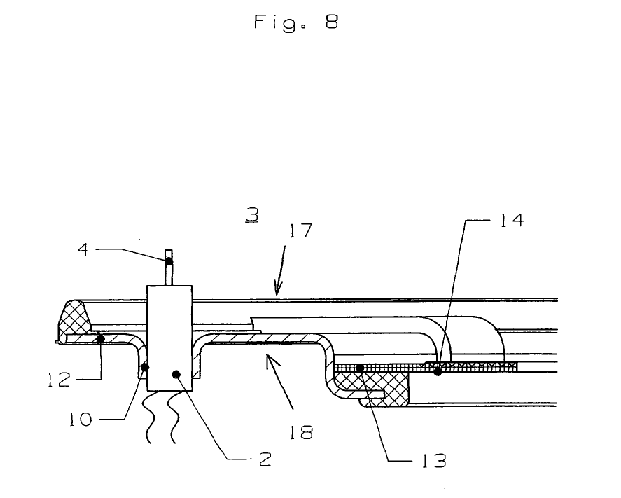

FIG. 8 shows a housing cover 17 with a sealing flange 18 made of drawn sheet metal. On the side of the inner circumference of the housing cover 17 there is disposed a seal 13 with a sealing lip 14. The housing cover 17 is provided with a recess 10 in which a sensor device 2 is fastened. The measuring probe 4 of the sensor device 2 extends into the space 3 to be sealed off and during operation is exposed to the lubricant.

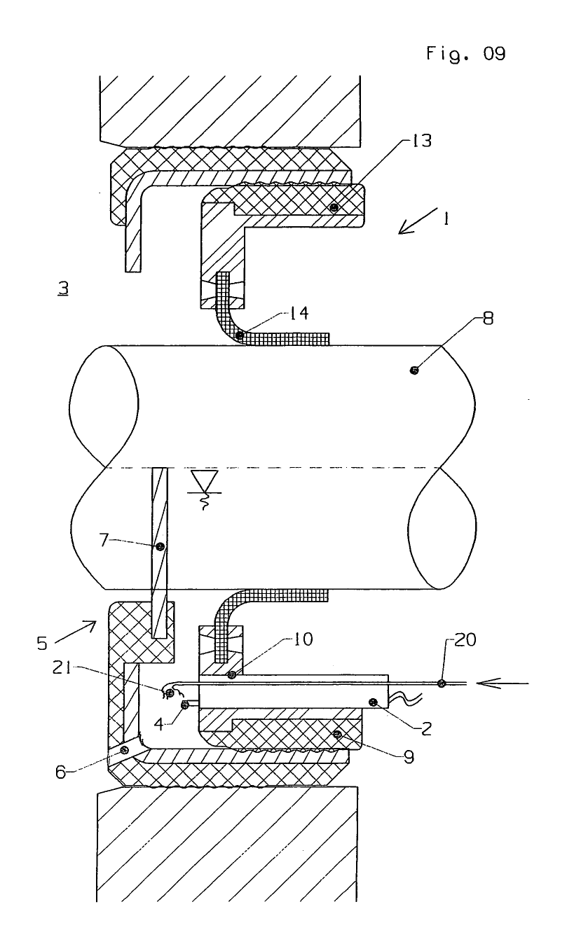

FIG. 9 shows the sealing system of FIG. 3. The sealing lip 14 of seal 13 is arched away from the space 3 that is to be sealed off. Into the sensor device 2 is integrated a cleaning line 20 that ends with a cleaning nozzle 21. The cleaning nozzle 21 is directed toward the measuring probe 4. When the measuring probe 4 is dirty, a cleaning agent can be blown in under pressure. The cleaning agent can consist of, for example, air, lubricant and/or a lubricant-compatible solvent.

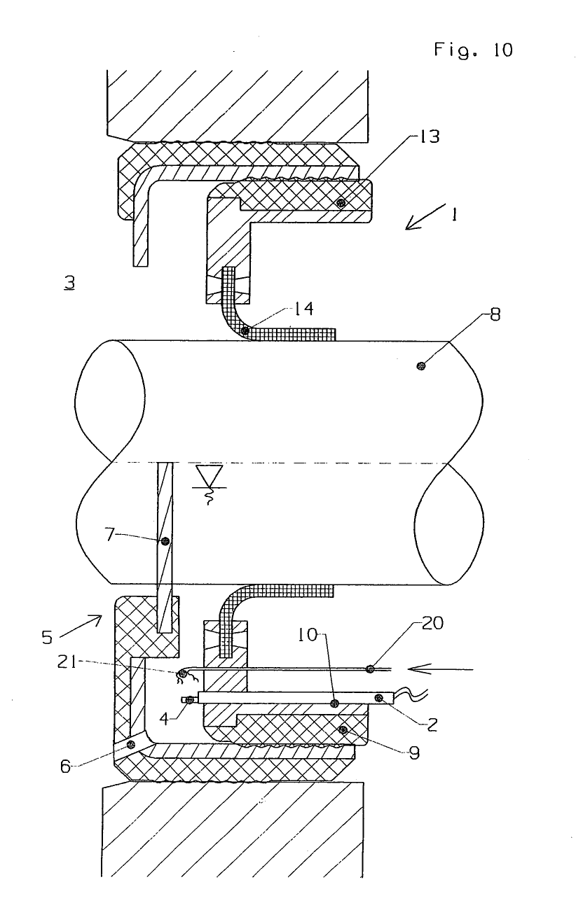

FIG. 10 shows the sealing system of FIG. 3. The sealing lip 14 of seal 13 is arched away space 3 that is to be sealed off. Into the seal 13 is integrated a cleaning line 20 that ends with a cleaning nozzle 21. The cleaning nozzle 21 is directed toward the measuring probe 4. When the measuring probe 4 is dirty, a cleaning agent can be blown in under pressure.

The description of the invention is merely exemplary in nature and, thus, variations that do not depart from the gist of the invention are intended to be within the scope of the invention. Such variations are not to be regarded as a departure from the spirit and scope of the invention.

1. A sealing system comprising:
a seal with a sealing lip; and
a sensor device with a measuring probe, the measuring probe extending into a space to be sealed off
wherein the measuring probe is exposed to the medium to be sealed off in the space in which it extends.

2. The sealing system as defined in claim 1, wherein in the space to be sealed off there is disposed a retaining device that retains the medium to be sealed off, the measuring probe extending into the retaining device.

3. The sealing system as defined in claim 2, wherein the retaining device is fastened to the seal.

4. The sealing system as defined in claim 2, wherein the retaining device is provided with a retaining lip which at least partly surrounds a shaft

5. The sealing system as defined in claim 4, wherein the retaining lip surrounds the shaft by at least partly touching it.

6. The sealing system as defined in claim 2, wherein the retaining device is fastened to the sensor device.

7. The sealing system as defined in claim 2, wherein the retaining device is provided with a draining hole.

8. The sealing system as defined in claim 1, wherein the measuring probe is a transmitter for measuring the age of the medium to be sealed off.

9. The sealing system as defined in claim 1, wherein the measuring probe is a transmitter for measuring at least one of temperature, pressure, and filling quantity of the medium to be sealed off.

10. The sealing system as defined in claim 1, wherein the seal is provided with a support element, the support element having a recess in which the sensor device is disposed.

11. The sealing system as defined in claim 1, further comprising a cleaning arrangement including a cleaning line and a cleaning nozzle, the cleaning nozzle directed toward the measuring probe.

12. A housing cover comprising the sealing system as defined in claim 10, wherein the support element is designed as a sealing flange with a recess, the sensor device being disposed in the recess.

13. The housing cover as defined in claim 12, wherein the sealing flange is made of an injection-molded plastic material.

14. The housing cover as defined in claim 12, wherein the sealing flange is made of a metallic material.
